(19) United States
(12) Patent Application Publication
(10) Pub. No.: US 2011/0314104 A1
(43) Pub. Date: Dec. 22, 2011

(54) System and Method for Selective Automatic Electronic Access of Personal Data

(76) Inventor: David Gray, Frisco, TX (US)

(21) Appl. No.: 13/163,021

(22) Filed: Jun. 17, 2011

Related U.S. Application Data
(60) Provisional application No. 61/355,957, filed on Jun. 17, 2010.

(51) Int. Cl. G06F 15/16

(52) U.S. Cl. 709/205

(57) ABSTRACT

A system and method for selective automatic electronic access to personal data. A content distribution system server having a relational database and user navigation facility is accessible via the Internet. Users create memberships and designate recipients, method of delivery, recipient-specific content, and triggering events, and upload this information to the content distribution system server.

### PRIORITY STATEMENT & CROSS-REFERENCE TO RELATED APPLICATIONS

This application claims priority from co-pending U.S. Application No. 61/355,957, entitled “System and Method for Selective Automatic Electronic Access of Personal Data” and filed on Jun. 17, 2010, in the names of David Gray et al.; which is hereby incorporated by reference for all purposes.

### TECHNICAL FIELD OF THE INVENTION

This invention relates, in general, to electronic communications and, in particular, to a system and method for the selective automatic electronic transmission of personal data at a time in the future.

### BACKGROUND OF THE INVENTION

Without limiting the scope of the invention, the background will be discussed with respect to memorials used to commemorate the life and death of a loved one, as an example. Last wills and testaments are legal declarations by which a person, the testator, names one or more persons to manage his estate and provide for the transfer of property at death. Wills and testaments may also include last words to loved ones which offer comfort, insight into death, and lessons about living. These communications, while priceless, have not evolved to leverage newer technologies that enable posthumous communication by memoralizing life stories while the individual is alive and transmitting these life stories at a later time after the individual's death. Moreover, beyond the death industry, many different people in different situations require a system able to record data for distribution at a later time following a particular event, date certain, or expiration of a period of time or clock.

### SUMMARY OF THE INVENTION

It would be advantageous to achieve a system and method for selective automatic electronic access of personal data. It would also be desirable to enable a computer-based solution that would honor individual legacies. To better address one or more of these concerns, in one aspect of the invention, such a system and method are disclosed for a content distribution system server having a relational database and user navigation facility, which is accessible via the Internet. Users create memberships and designate recipients, method of delivery, recipient-specific content, and triggering events, and upload this information to the content distribution system server.

In one embodiment of the method for selective automatic electronic access to personal data, participants, all having a common interest in the welfare of the user, are connected in a dormant contact network by the user. Once a triggering event occurs and the authenticity of the communication and recipient are verified, the participant is granted access to a private space including personal information designated for the participant about the welfare of the user and the triggering event. Additionally, the participant is given the opportunity to join an active network including a collaboration space for exchanging information with other verified participants regarding the welfare of the user and the triggering event. In another aspect, videos are delivered in the future to siblings even if death does not occur. These and other aspects of the invention will be apparent from and elucidated with reference to the embodiment(s) described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a functional block diagram of one embodiment of a system for the selective automatic electronic transmission of personal data;

FIG. 2 is a functional block diagram of one operational embodiment of the system depicted in FIG. 1; and

FIG. 3 is a data flow diagram of one embodiment of the system.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

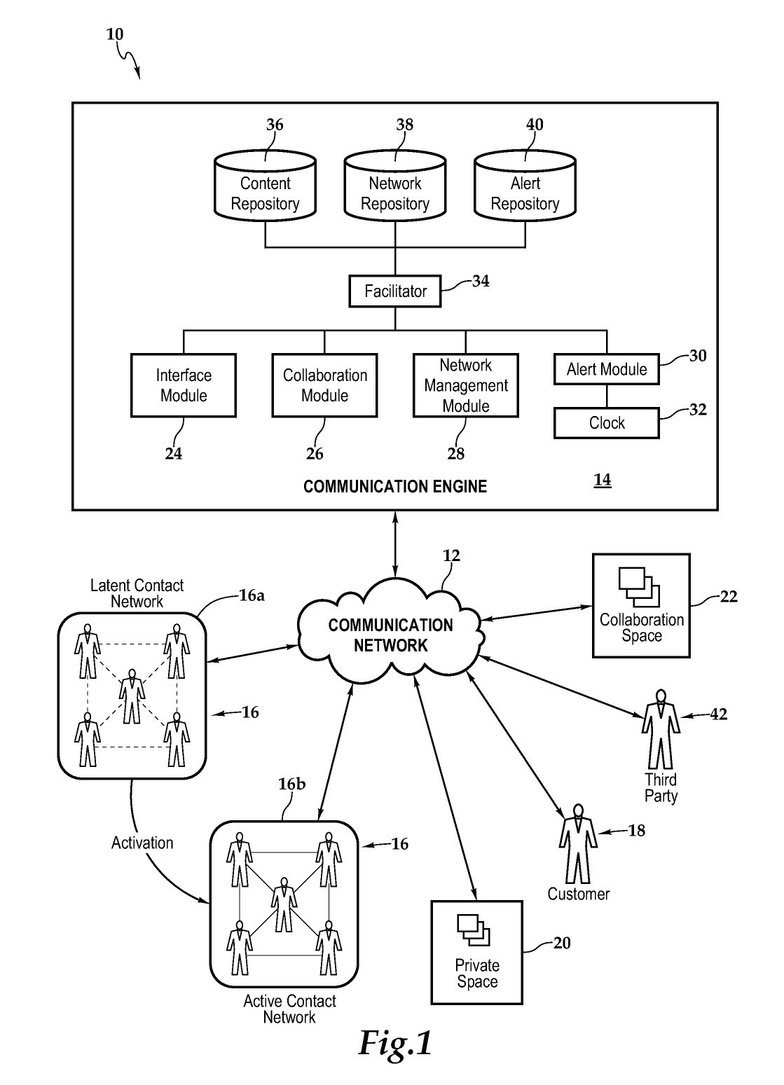

Referring initially to FIG. 1, therein is depicted a system (and associated method) for the selective automatic electronic transmission of personal data that is schematically illustrated and generally designated 10. A communication network 12, which may include the Internet, cellular telephone system, and the Plain Old Telephone System (POTS), for example, connects a communication engine 14, a network of participants 16 (latent 16A and active 16B), a customer 18, a private space 20, and a collaboration space 22 in any type of network deployment and file distribution protocol, whether, for example, server-based, peer-to-peer based, or a combination thereof.

The communication engine 14 may comprise any combination of hardware, software, and firmware. Similarly, the customer 18 and network participants 16 may be utilizing any combination of hardware, software, and firmware to connect to the communication engine 14. With respect to the communication engine 14, more specifically, the communication engine includes an interface module 24, a collaboration module 26, a network management module 28, an alert module 30 coupled to a clock 32, a facilitator 34, a content repository 36, a network repository 38, and an alert repository 40; all of which may be interconnected in any manner.

The interface module 24 is a module that provides the interface necessary for a customer to create an account and upload various content or instances of media, which are directed by the facilitator 34 to the content repository 36. The collaboration module 26 manages both the private space 20 and the collaboration space 22. The private space being content intended only for a particular participant. On the other hand, the collaboration space 22 provides an application space for real-time communication and collaboration about the user or customer and the triggering event. The network management module 28 with access to the network repository 38 handles the participants 16 and the respective statuses within the latent network 16A and active network 16B. The alert module 30, clock 32, and the alert repository 40 handle triggering events, whether the expiration of a clock or the receipt of an alert from a keymaster, such as third-party 42.

The system 10 provides for an activity log and mail system. The activity log shows all the activity of the user's account. For his or her own protection the user cannot make changes to the log. By looking at the log, a user can determine when someone else has accessed his or her account without permission.

The mail system is for system messages to provide the user with information about updates and a new features. Optionally, the user may choose to have a notification email sent to his or her normal email account to be notified of any system messages. The user can specify the from address, subject, and body of the notification email.

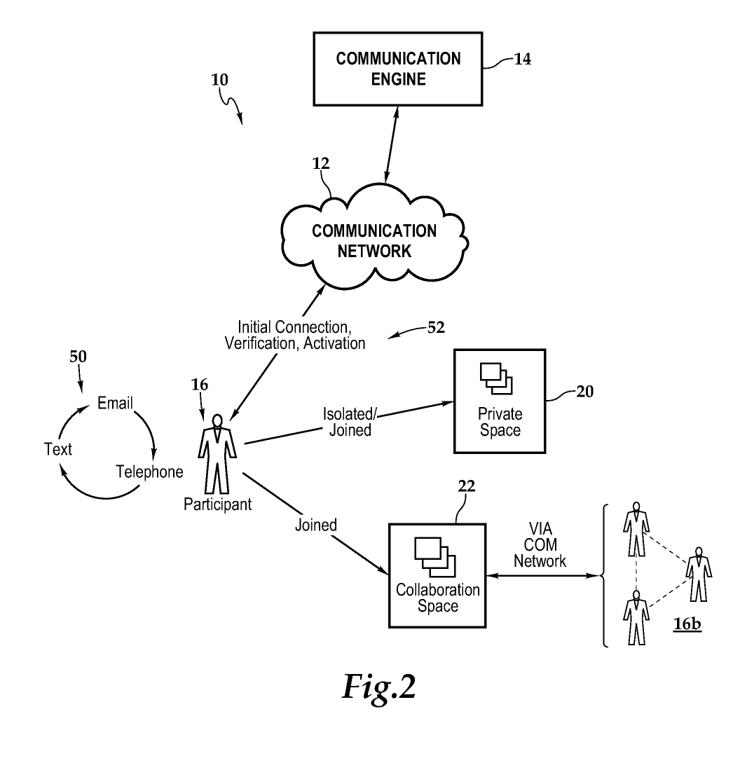

Referring now to FIG. 2, during operation, users or customers, such as customer 18, create memberships with the system and designate recipients (participants), method of delivery, participant-specific content, and triggering events, and upload this information to the content distribution system server and, in particular, the aforementioned communication engine 14. The content distribution system 10 utilizes a content module or repository 36 at the communication engine 14 to maintain the recipient-specific content until a triggering event occurs. The network management module 28 interfaces with various communication means in the communication network 12, such as the Internet, cellular telephone network, and POTS. When a triggering event occurs, the content distribution system 10 makes the recipient-specific content available to the designated recipients in the required format. The triggering event will depend on the application and may include the expiration of a clock or entry of a keymaster passcode. In one embodiment, the user may be periodically sent a reminder about the pending triggering event.

The content distribution system 10 may be implemented in a variety of embodiments. By way of example, in a “no foul play” embodiment, a person who believes that he or she may be in a life threatening situation, may register with the system as a user and establish an account. The user may then establish a list of designated recipients and upload content relevant to the perceived life threatening situation. A clock may be established and if the user does not check-in with the system prior to the expiration of the clock, the content distribution system sends out the content to the designated recipients or, alternatively, sends an alert to the designated recipients advising of the availability of the content. The trigger operating under the theory that no check-in signifies the occurrence of the life-threatening situation.

Similarly, in a “campus watch dog” embodiment, an individual of a business or educational institution may register with the system administered by or on behalf of the business or educational institution. Once registered, such an individual would interact with the “campus watch dog” embodiment of the system similar to how a person interacts with the “no foul play” embodiment of the system.

In another embodiment named “military savior,” a member of the armed forces uploads content to be distributed upon his or her death. A custodian is entrusted as a keymaster to enter a unique passcode to cause the delivery of the content upon the death of the armed forces member. The content may all be delivered at once or a portion of the content may be programmed to be delivered at a predetermined times such as a holiday or loved one's birthday. In another implementation, the military savior embodiment allows the prerecording and distribution of select content on a normal, daily basis during the life of the armed forces member. The following table summaries four exemplary embodiments.

Similarly, in a “loving last memories” or mylegacy.org embodiment, a user of the system uploads contents to be distributed upon his or her death. The user may receive periodic reminders to update the contact information of the custodians and of the recipients. Reminder may include any other information related to the account, such as information related to a log of the account activity, recipients associated with the account, custodians associated with the count, and so forth.

Further embodiments may include some or all of any of the features described in each of the example embodiments. For example, a user may receive a clock expiration warning and periodic reminders.

TABLE I
Exemplary Embodiments

| | No Foul | Campus | Military | |
|---|---|---|---|---|
| | Play | Watch Dog | Savior | Mylegacy.org |
| Event | Expiration | Expiration | Keymaster | Keymaster |
| Trigger | of a Clock | of a Clock | | |
| Network | Any type | Any type of | Any type of | Any type of |
| Management/ | of | delivery | delivery | delivery |
| Message | delivery | | | |
| Module | | | | |
| Collaboration/ | Any type | Any type of | Any type of | Any type of |
| Content | of | content | content | content |
| Module | content | | | |
| Reminder | Clock | Clock | N/A | Periodic |
| | expiration | expiration | | reminder |
| | warning | warning | | |

Continuing reference to FIG. 2, wherein a system and method for selective automatic electronic access to personal data is depicted. Participants, such as participant 16 are connected to the communication engine in the latent or dormant contact network (16A in FIG. 1), and share a common interest in the welfare of the user. Communication between the communication engine 14 and the participants 16 is not enabled until a triggering event is detected at the communication engine 14. Upon the detection of the triggering event, the participants of the triggering event are notified by cycling through a message modality cycle (arrow 50) until contact is made. The notification is verified and authenticated as shown by arrow 52. For example, a challenge/response protocol may be utilized to verify and authenticate the triggering event notification.

Upon receipt of the authentication and verification, access to a private space 20 including personal information designated for the participant 16 about the welfare of the user and the triggering event is granted to the participant 16. Additionally, the participant is invited to join an active network including a collaboration space 22 for exchanging information with other verified participants 16B regarding the welfare of the user and the triggering event. That is, for each verified participant, upon receipt of acceptance to the invitation from the verified participant, there is an activation of the participant by moving the participant from the dormant contact network to the active contact network.

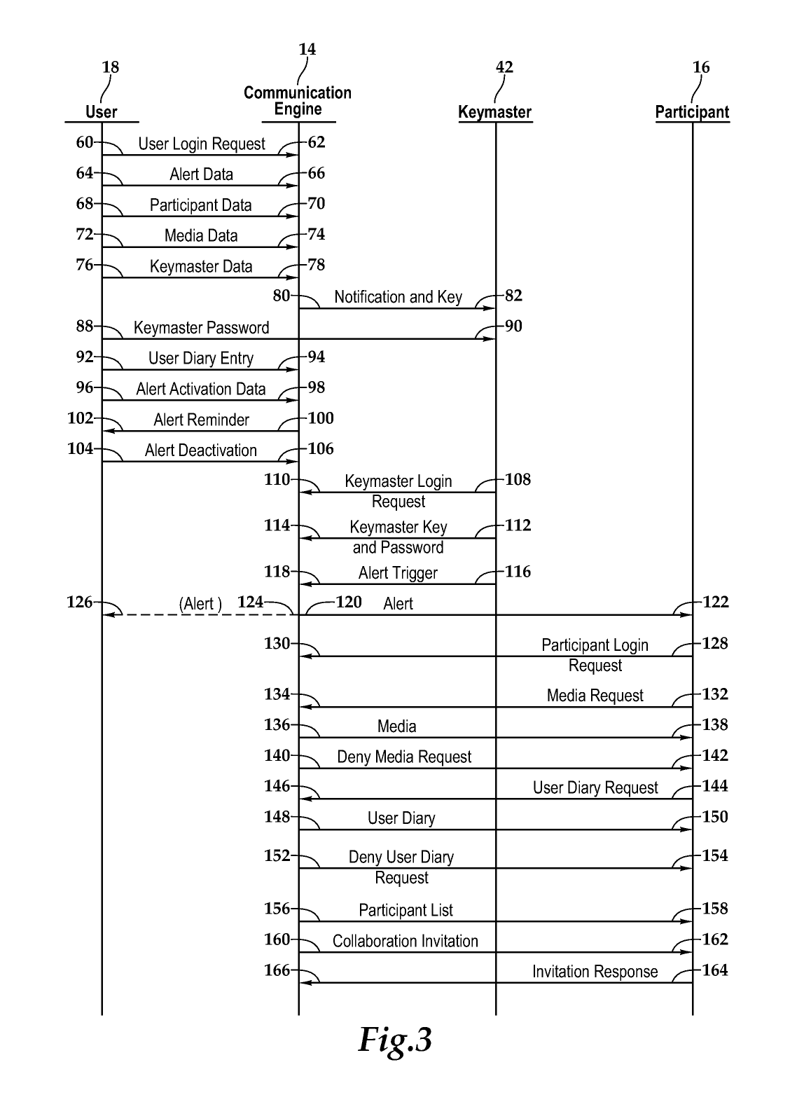

FIG. 3 is a diagram of the data flowing within system 10. A user 18 sends 60 a login request to the communication engine 14 and the communication engine 14 receives 62 the login request from the user 18. The request includes a password from the user to verify the user.

After being verified and as a part of creating or managing an alert, the user sends 64 alert data to communication engine 14 and communication engine 14 receives 66 the alert data. An alert is a message created by the user in the form of an e-mail, text message, voice message, and so forth, that is delivered to one or more participants 16. The alert will be executed, i.e., the message will be sent to the participants, if the alert has not been disarmed or deactiviated by the user prior to the alert being triggered.

Alert data includes a name for the alert, a start time, a re-activation time, a re-activation flag, an end time, and a reminder data.

The start time indicates the time of execution of the alert. This is the time the alert will be sent unless the user deactivates the alert.

The re-activation time indicates how long after the start time that the alert will be automatically rescheduled and reactivated. For example, if the re-activation time is set as “every day,” in the alert will be rescheduled exactly twenty-four hours after the start time.

The re-activation flag allows the user to select whether the alert is to reset and rearm itself after the alert has been executed. As a default, the re-activation flag may indicate that once an alert executes, the alert becomes inactive unless the alert is manually reactivated.

The end time indicates when the alert is to stop being eligible for automatic rescheduling. By using the end time, an alert may be automatically reactivated each time the re-activation time has elapsed after the start time until the end time is reached. For example, when the re-activation time is “every day,” and the end time is one week after the start time, then the alert will be automatically rescheduled every day until one week after the start time has past.

The reminder data indicates when a reminder will be sent prior to executing the alert. The reminder may be in the form of an email, text message, or voice message. The reminder data may indicate that the reminders are to be sent to the user at a fixed time before the alert is executed, such as thirty minutes, one hour, two hours, one day, two days, and so forth. Additionally, the reminder may be intentionally misleading and a take the form of a cryptic or seemingly unrelated message.

The user sends 68 participant data to communication engine 14 and communication engine 14 receives 70 the participant data. The participant data indicates which participants 16 will receive a message via the alert. The participant data may also include the participant's: email address, mobile number, and home or land line number. The system 10 may allow the user 18 to assign individual photos to the participants to easily navigate the participants. Each participant associated with each alert can have a specific delivery method of the message of the alert, i.e., by email, text message, or voice message. Also, the user 18 may submit a question that the participant 16 must successfully answer in order to access the message of the alert. In the case where the participant cannot be reached by the contact information provided, the provided contact information may be used to determine the participant's current contact information.

The user 18 sends 72 media data to communication engine 14 and communication engine 14 receives 74 the media data from the user 18. The media data includes actual photos, videos, audio files, or other documents and may also include links to the actual photos, videos, audio files, and other documents. Each of the files or links may be associated with any number of alerts and participants. Additionally, the user 18 may include notes for any of the files included in the media data. The notes may help the user 18 to identify the files or may help the participant 16 understand why a the files were included.

The media data may also include diary selection data that indicates of whether a participant will be able to access a diary of the user that is hosted by the system after an alert is triggered. The user diary is a collection of entries made by the user much like a traditional diary.

The user 18 sends 76 keymaster data to communication engine 14 and communication engine 14 receives 78 the keymaster data from the user 18. The keymaster data includes the keymaster's name, a password for the keymaster to use, an indication of which alerts the keymaster can trigger, and contact information for the keymaster. The password for the keymaster to use should be different from the password used by the user to log into the system 10.

On creating a new keymaster, the system 10 creates a unique key for that particular keymaster. The keymaster must provide the password and the key in order to login and trigger an alert. The keymaster 42 cannot access the user's account, the user's alerts, or the user's media. Rather, the keymaster 42 has the ability to activate any of the alerts associated with that keymaster by the user.

After creating a new keymaster, the user 18 may elect to have the communication engine 14 send an email to the keymaster notifying him or her that the user 18 selected him or her as a keymaster for one or more alerts. If the user elects to send the notification, the communication engine 14 sends 80 the notification and the key to the keymaster 42 and the keymaster 42 receives 82 the notification and key from the communication engine 14. The notification notifies the keymaster that he or she has been selected by the user to be able to trigger an alert and directs the keymaster on how to access system 10.

The user sends 88 the password directly to the keymaster 42 and the keymaster 42 receives 90 the password directly from the user 18 without using the communication engine 14. This is to ensure the identity of the keymaster.

The user 18 sends 92 one or more user diary entries to the communication engine 14 and the communication engine 14 receives 94 one or more user diary entries from the user 18. The user diary allows the user to record information in a private diary or blog format. It will only be visible to participants that are granted specific access to the user diary in relation to an alert.

The user 18 sends 96 alert activation data to communication engine 14 and communication engine 14 receives 98 the alert activation data from the user. The alert activation data arms and activates an alert created by the user 18.

The communication engine 14 optionally sends 100 an alert reminder to the user 18 and the user 18 optionally receives 102 the alert reminder from the communication engine 14. The alert reminder gives the user 18 a chance to deactivate the alert before it is sent out to all of the participants 16 selected by the user 18.

If he or she is able to, the user 18 sends 104 alert deactivation data to communication engine 14 and communication engine 14 receives 106 the alert deactivation data from the user 18. The alert deactivation data indicates which of one or more alerts are to be deactivated. The alerts with a re-activation time are rescheduled to the next re-activation time.

The keymaster 42 sends 108 a keymaster login request to the communication engine 14 and the communication engine 14 receives 110 the keymaster login request from the keymaster 42. In order to login, the keymaster sends the key and password originally given to the keymaster 42 by the communication engine 14 and the user 18, respectively. After successfully logging in, the keymaster 42 sends 116 an alert trigger to the communication engine 14 and the communication engine 14 receives 118 the alert trigger. The alert trigger initiates the execution of an alert as selected by the user 18.

After the keymaster 42 logs in, he or she receives directions on how to activate an alert and the name of the user for each of the alerts the keymaster can activate. The keymaster then conforms his or her authority to release the alerts, for example, by clicking on a check box. As a precautionary step, the keymaster may be presented a nag screen pop up to ensure that the keymaster really wants to activate any selected alerts. After triggering an alert, the keymaster is informed that the selected alert was sent. The keymaster's login is then deactivated for the user and alert that was activated.

An alert may be triggered by the keymaster or by the passing of the start time of an active alert. The communication engine 14 sends 120 the alert to participant 16 and participant 16 receives 122 the alert. Optionally, the communication engine 14 sends 124 the alert to the user 18 and the user 18 receives the alert.

The participant 16 sends 128 a login request to the communication engine 14 and the communication engine 14 receives 130 the login request from the participant 16. As a part of the login process, the participant 16 may be required to declare via an authorization check box that he or she is the particular person selected by the user to be the participant 16.

The participant 16 may also be asked to correctly answer the question defined by the user specifically for the participant. In this case, the participant 16 will only be able to retrieve the message, media, and user diary associated with the alert after providing the correct answer.

After receiving the authentication/verification of the participant 16, the communication engine 14 may then provide a participant list to the participant 16. The participant list is a list of all the participants selected by the user and associated with the alert received by participant 16. This allows the participant 16 to see who has been contacted with the alert.

After successfully logging in, the participant 16 sends 132 a media request to the communication engine 14 and the communication engine 14 receives 134 the media request from the participant 16. The communication engine 14 sends 136 the media related to the media request to the participant 16 and the participant 16 receives 138 the media related to the media requests from the communication engine 14. For security, a direct link to the media is not provided. The media is transferred using a custom player that reads and media from a secure location and transfers it byte-by-byte to a browser of the participant 16.

Access to the media may be limited by an expiration period so that instead of sending the media, the communication engine 14 sends 140 a denial of the media request to the participant 16 and the participant 16 receives 142 the denial of the media request from the communication engine 40. The expiration period may be for 30 days after the alert is activated.

Access to the media may also be limited by a download counter so that a denial of a media request is sent rather than the media being sent. The download counter may be such that the media can be downloaded no more than three times via the communication engine 14.

If access to the user diary was provided by the user 18, the participant 16 may send 144 a user diary request to the communication engine 14 and the communication engine 14 receives 146 the user diary request from the participant 16. The communication engine 14 sends 146 the user diary to the participant 16 and the participant 16 receives the user diary as a readable document from the communication engine 14.

The user diary is converted to a readable document, such as a portable document format file, prior to the user diary being sent to the participant 16. In receiving the user diary as a readable document, the participant 16 can easily and read and print out the diary of the user. This conversion may happen at the time of the alert in order to freeze the state of the user diary. The conversion may also happen when the request for the user diary is received by the communication engine 14.

Access to the user diary may be limited by an expiration period or download counter so that instead of sending the user diary, the communication engine 14 sends 152 a denial of the user diary request to the participant and the participant 16 receives 154 the denial of the user diary request from the communication engine 14. The expiration period may be for 30 days after the alert is activated and the download limit may be set to three downloads.

After the participant 16 successfully logs in, the communication engine 14 sends 160 a collaboration invitation to the participant 16 and the participant 16 receives 134 the media request from the communication engine 14. The participant 16 then sends 164 an invitation response to the communication engine 14 and the communication engine 14 receives the invitation response from the participant 16. When the invitation response indicates that the collaboration invitation is accepted by the participant 16, the participant 16 becomes activated and is moved from a dormant contact network to an active contact network.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A method for selective automatic electronic access to personal data, the method comprising:
connecting a plurality of participants to a communication engine in a dormant contact network via a communication network, the plurality of participants having a common interest in the welfare of a user;
providing non-enabled communication between the communication engine and the plurality of participants;
detecting a triggering event at the communication engine;
notifying each of the plurality of participants of the triggering event and requesting authentication/verification of receipt of notification;
for each of the participants, upon receipt of the authentication/verification, granting access to a private space including personal information designated for the participant about the welfare of the user and the triggering event;
inviting each of the plurality of verified participants to join an active network including a collaboration space for exchanging information with other verified participants regarding the welfare of the user and the triggering event; and
for each of the verified participant, upon receipt of acceptance to the invitation from the verified participant, activation of participant by moving the participant from the dormant contact network to the active contact network.

2. The method as recited in claim 1, wherein the personal information provided in the private space to a first participant is at least partially identical to personal information provided in a private space to a second participant.

3. The method as recited in claim 1, wherein requesting verification further comprises issuing a predetermined challenge/response.

4. The method as recited in claim 1, wherein notifying each of the plurality of participants further comprises cycling through a message modality cycle for a portion of the plurality of participants.

5. The method as recited in claim 1, further comprising:
receiving one more entries for a user diary of the user and diary selection data indicating which of the plurality of participants may access the user diary after the triggering event;
converting the user diary to a readable document; and
for each of the participants indicated in the diary selection data, making the user diary available for download as a readable document.

6. The method as recited in claim 1, further comprising:
sending an alert reminder to the user before detecting the triggering event at a time selected by the user and related to the alert; and
receiving alert deactivation data from the user prior to detecting the triggering event.

7. The method as recited in claim 1, further comprising: connecting one or more keymasters selected by the user to the communication engine, the keymasters having the ability to activate the triggering event.

8. The method as recited in claim 1, wherein the personal information must be accessed prior to an expiration period expiring.

9. The method as recited in claim 1, wherein the personal information must be accessed prior to a download limit being reached.

10. The method as recited in claim 1, further comprising: for each of the participants, upon receipt of the authentication/verification, providing a participant list identifying each of the participants associated with the triggering event.

11. An apparatus for selective automatic electronic access to personal data, the apparatus comprising:
a communication engine configured to:
connect a plurality of participants in a dormant contact network via a communication network, the plurality of participants having a common interest in the welfare of a user;
provide non-enabled communication between the communication engine and the plurality of participants;
detect a triggering event;
notify each of the plurality of participants of the triggering event and request authentication/verification of receipt of notification;
grant access to a private space including personal information designated for each participant about the welfare of the user and the triggering event, upon receipt of the authentication/verification;
invite each of the plurality of verified participants to join an active network including a collaboration space for exchanging information with other verified participants regarding the welfare of the user and the triggering event; and
move the verified participants from the dormant contact network to the active contact network upon receipt of acceptance of the invitation from the verified participants.

12. The apparatus as recited in claim 10, wherein the personal information provided in the private space to a first participant is at least partially identical to personal information provided in a private space to a second participant.

13. The apparatus as recited in claim 10, wherein the communication engine is further configured to issue a predetermined challenge/response when requesting verification.

14. The apparatus as recited in claim 10, wherein the communication engine is further configured to cycle through a message modality cycle for a portion of the plurality of participants when notifying each of the plurality of participants.

15. The apparatus as recited in claim 10, wherein the communication engine is further configured to:
receive one more entries for a user diary of the user and diary selection data indicating which of the plurality of participants may access the user diary after the triggering event;
convert the user diary to a readable document; and
make the user diary available for download as a readable document for each of the participants indicated in the diary selection data.

16. The apparatus as recited in claim 10, wherein the communication engine is further configured to:
send an alert reminder to the user before detecting the triggering event at a time selected by the user and related to the alert; and
receive a deactivation request from the user prior to detecting the triggering event.

17. The apparatus as recited in claim 10, wherein the communication engine is further configured to: connect one or more keymasters selected by the user to the communication engine, the keymasters having the ability to activate the triggering event.

18. The apparatus as recited in claim 10, where in the personal information must be accessed prior to an expiration period expiring and prior to a download limit being reached.

19. The apparatus as recited in claim 10, wherein the communication engine is further configured to: provide a participant list identifying each of the participants associated with the triggering event to each of the participants, upon receipt of the authentication/verification.

20. A system for selective automatic electronic access to one or more media, the method comprising:
means for receiving a user login request from a user;
means for receiving alert data from the user for an alert;
means for receiving participant data for the alert from the user, the participant data linking one or more participants identified by the user to the alert;
means for receiving media selection data for the alert from the user, the media selection data linking one or more media identified by the user to the alert;
means for receiving keymaster selection data for the alert from the user, the keymaster selection data linking one or more keymasters identified by the user to the alert;
means for transmitting a keymaster notification and keymaster key to a keymaster of the one or more keymasters;
means for receiving a keymaster password associated with the keymaster from the user;
means for receiving one or more entries for a user diary from the user;
means for receiving alert activation data from the user, the alert activation data identifying a start time and how ofter the alert is to activate and when an alert reminder should be transmitted;
means for transmitting an alert reminder to the user based on the alert activation data to remind the user that the alert will be sent to the participants identified in the participant data;
means for receiving keymaster login request from the keymaster;
means for receiving the keymaster key and the keymaster password associated with the keymaster;
means for receiving an alert trigger for triggering the alert from the keymaster;
means for transmitting the alert to the one or more participants based on the alert data and the participant data when the alert is not deactivated;
means for receiving a participant login request from a participant of the one or more participants;
means for receiving a request for the media associated with the participant from the participant;
means for transmitting the one or more media to the participant;
means for transmitting a request denial when the request for the media is received after the alert expires via one of an expiration period of the alert and a download limit counter, the expiration period based on when the alert was sent and the download limit counter allowing for a predetermined number of downloads of the one or more media;
means for receiving a request for the user diary from the participant;
means for transmitting the user diary to the participant;
means for transmitting a request denial when the request for the user diary is received after the alert expires via one of an expiration period of the alert and a download limit, the expiration period based on when the alert was sent and the download limit allowing for a predetermined number of downloads of the user diary;
means for transmitting a participant list to the participant, the participant list identifying the one or more participants associated with the alert;
means for transmitting a collaboration invitation to the participant;
means for receiving an invitation response from the participant.
